(19) United States
(12) Patent Application Publication
(10) Pub. No.: US 2025/0168172 A1
(43) Pub. Date: May 22, 2025

(54) OBSCURED LOCATION VERIFICATION

(71) Applicant: INTERNATIONAL BUSINESS MACHINES CORPORATION, ARMONK, NY (US)

(72) Inventors: JASON MATTHEW STAPELS, POUGHKEEPSIE, NY (US); RYAN BAIR, TILLSON, NY (US); ANTHONY GENNARO MANGIACAPRA, VESTAL, NY (US); NICHOLAS TUFANO, POUGHKEEPSIE, NY (US)

(21) Appl. No.: 18/517,540

(22) Filed: Nov. 22, 2023

(51) Int. Cl. H04L 9/40

(52) U.S. Cl. CPC H04L 63/107; H04L 63/083

(57) ABSTRACT

Obscured location verification may include: obtaining, by a computing device, location information associated with the computing device; generating, by the computing device, a hash of region data for each of a plurality of regions associated with the location information using a key associated with the computing device to produce a plurality of hashes; sending, by the computing device, the plurality of hashes to a server; and receiving, by the device from the server, authentication information from the server indicative of whether one or more of the plurality of regions is authenticated based upon a corresponding hash from the plurality of hashes.

### BACKGROUND

The present disclosure relates to methods, apparatus, and products for obscured location verification.

### SUMMARY

According to embodiments of the present disclosure, various methods, apparatus and systems for obscured location verification are described herein. In some aspects, obscured location verification includes obtaining, by a device, location information associated with the device. The method further includes generating, by the device, a hash for region data for each of a plurality of regions associated with the location information using a key associated with the device to produce a plurality of hashes. The method further includes sending, by the device, the plurality of hashes to a server. The method still further includes receiving, by the device, authentication information from the server indicative of whether one or more of the plurality of regions is authenticated based upon a corresponding hash from the plurality of hashes.

### BRIEF DESCRIPTION OF THE DRAWINGS

FIG. 1 sets forth an example computing environment for obscured location verification according to aspects of the present disclosure.

FIG. 2. sets forth another example computing environment for obscured location verification according to aspects of the present disclosure.

FIG. 3 is a process flow diagram illustrating an example region registration process for obscured location verification in accordance with embodiments of the present disclosure.

FIG. 4 is a process flow diagram illustrating an example authentication process for obscured location verification in accordance with embodiments of the present disclosure.

FIG. 5 is a flowchart illustrating an example method of obscured location verification in accordance with embodiments of the present disclosure.

FIG. 6 is a flowchart illustrating another example method of obscured location verification in accordance with embodiments of the present disclosure.

### DETAILED DESCRIPTION

Authentication mechanisms are often used for increasing security in network environments. For example, before a user can access a particular service provided over a network, a user device is often required to be authenticated prior to granting access to reduce fraudulent activity, cyber attacks, and other undesirable actions. Examples of authentication mechanisms include alphanumeric passwords, biometric passwords, multi-factor authentication (MFA), hard tokens, and soft tokens. As cyber attacks continue to become more prevalent and sophisticated, it has become more difficult for digital services to verify the legitimacy of a user that is authenticating with the service. The security of an authentication request may be enhanced by including the physical location of the user at the time of authentication. However, some users may object to providing their location to the service for privacy reasons.

In various embodiments, obscured location verification is achieved by obtaining location data of a geographical region associated with a location of a computing device, hashing the location data based upon a secret key, and verifying the hash against a customizable set of valid regions. By using a hashed location region, knowledge of the physical location of the computing device by one or more services is prevented while preserving the ability to verify that the computing device is within one of a predetermined set of hashed regions preselected by a user of the computing device. In particular embodiments, the secret key may include a password/passphrase or device-generated key unique to the computing device. In particular embodiments, the region data is obfuscated and unique per user such that the user cannot be tracked back to a specific location. In one or more embodiments, a region is a specific area encompassing the location of the computing device which may be as accurate as the user of the computing device desires as long as the region is large enough to cover the area from which the computing device is intended to authenticate. In a particular embodiment, a region may be defined by a geohash as is well known in the art.

In an example sequence of authentication according to an embodiment, a registration process is performed in which a computing device initiates adding of a new authentication region with a service, and the service provides session details to the computing device which includes an indication of region size limits for regions to be selected by a user of the computing device. The computing device captures location information associated with the computing device, requests a region size from the user, and receives an indication of the region size from the user. The computing device hashes the region of the indicated region size using a secure key, such as a device-generated signature or user password. The computing device sends a message including the hash to register the new hashed authentication region to the service, and the service stores the hashed authentication region in a set of authenticated hashed regions associated with the computing device. In one or more embodiments, the registration process may be repeated by the computing device for a number of different regions, each of which may be of a different region size. In a particular embodiment, the service confirms the new authentication region with the user via an out-of-band communication such as an email or text message.

During authentication of the computing device during a request to access the service according to an embodiment, the user logins into the service using the computing device, and the computing device sends authentication details to the service. The service establishes an unvalidated session with the computing device that includes a location challenge and indication of region size limits. The computing device captures location information associated with the location of the computing device. For each possible region size including the location of the computing device as provided by the location information, the computing device hashes each region size with the secure key and sends the hashed authentication regions to the service. The service verifies whether any of the hashed authentication regions match one or more of the hashed authentication regions in the stored set of authenticated hashed regions. If one or more of the received hashed authentication regions matches a stored authenticated hashed region, the service validates the session with the computing device. If none of the received hashed authentication regions matches a stored authenticated hashed region, the service invalidates the session with the computing device. The computing device then notifies the user of the results of the authentication attempt.

Various embodiments allow for authenticating a user based on both their password and a hashed region by providing a predetermined set of valid hashed regions. In various embodiments, region data is obfuscated and is unique per user such that it cannot be tracked back to a specific location.

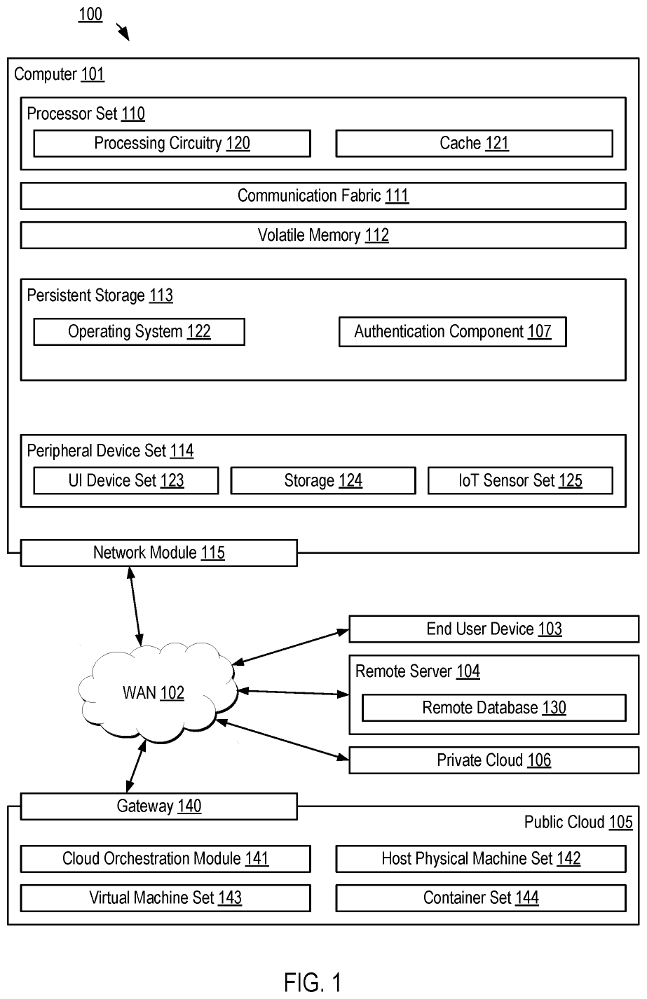

FIG. 1 sets forth an example computing environment according to aspects of the present disclosure. Computing environment 100 contains an example of an environment for the execution of at least some of the computer code involved in performing the various methods described herein, such as authentication component 107 configured to facilitate the obscured location verification operations described herein. In addition to authentication component 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and authentication component 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Such computer processors as well as graphic processors, accelerators, coprocessors, and the like are sometimes referred to herein as a processing device. A processing device and a memory operatively coupled to the processing device are sometimes referred to herein as an apparatus. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in authentication component 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in authentication component 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

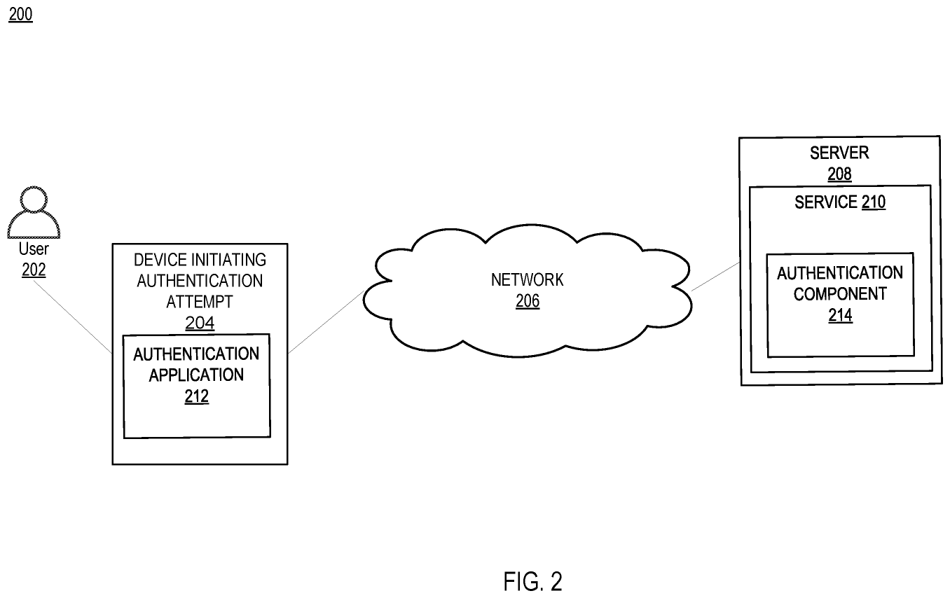

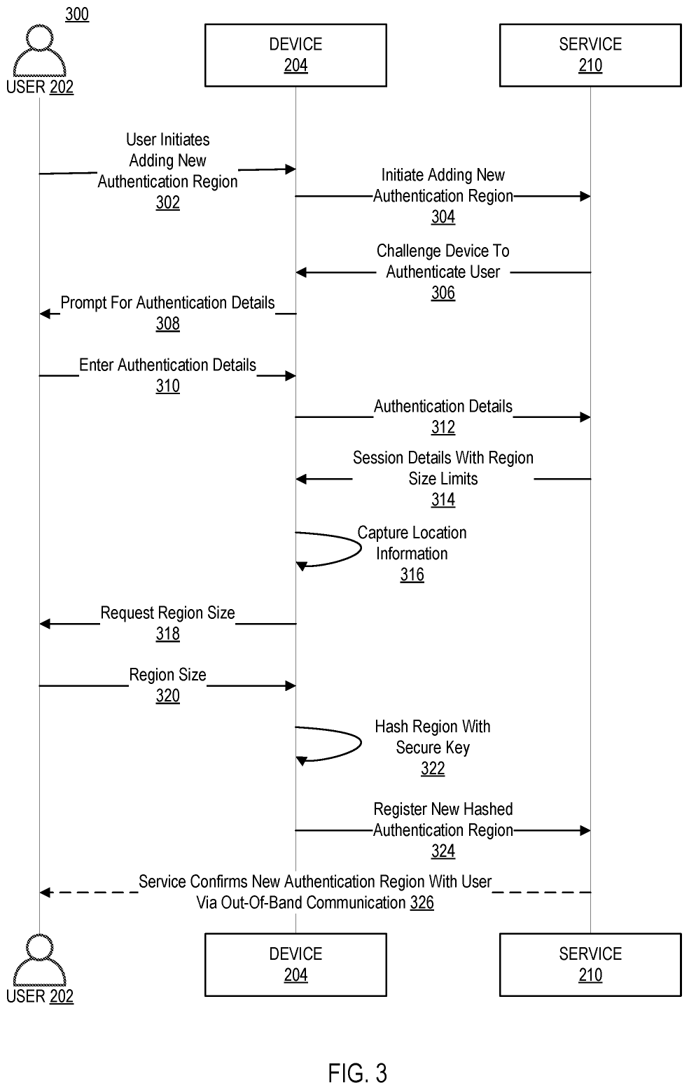

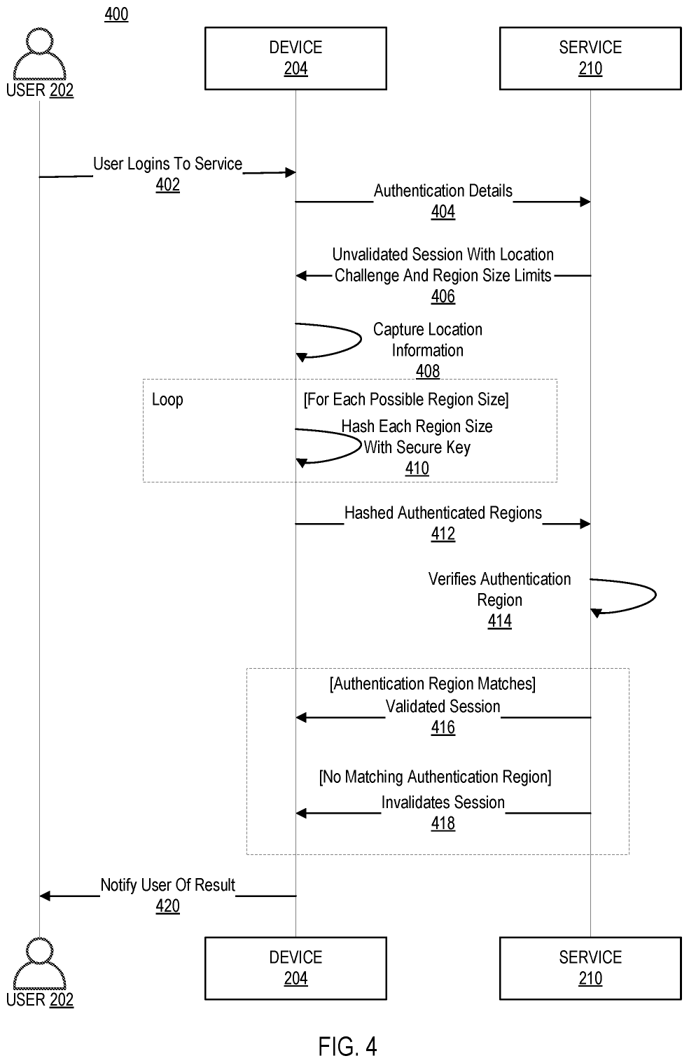

For further explanation, FIG. 2 sets forth an example computing environment for obscured location verification according to aspects of the present disclosure. The computing environment 200 of FIG. 2 includes a device 204 in communication with a server 208 via a network 206. In the example of FIG. 2, the server 208 is configured to provide a service 208 to one or more computing devices, and a user 202 of the device 204 is initiating an authentication attempt to establish a session with the server 208 to receive the service 210. The device 204 includes an authentication application 212 and the server 208 includes an authentication component 214 that are each configured to facilitate authentication of the device 204 with the service 210 as described herein with respect to various embodiments. In one or more embodiments, the computing environment 200 is configured to allow a user of the device 204 to register one or more authentication regions with the server 208, and authenticate the device 204 with the service 210 as further described with respect to FIG. 3 and FIG. 4, respectively.

FIG. 3 is a process flow diagram illustrating an example region registration process 300 for obscured location verification in accordance with embodiments of the present disclosure. During the region registration process 300, the user 202 desires to register a new authentication region of a size selected by the user 202 with the service 210 to allow for later authentication of the device 204 with the service 210 based on the authentication region. The registration process 300 includes the user 202 initiating 302 adding a new authentication region using the device 204, and in response the device 204 initiates 304 adding a new authentication region with the service 210. The service 210 then challenges 306 the device 204 to authenticate the user 202, and the device 204 prompts 308 the user for user authentication details. In particular embodiments, the authentication details may include one or more of a username or a password associated with the user 202.

The user 202 enters 310 the authentication details to the device 204, and the device 204 sends 312 the authentication details to the service 210. In an alternative embodiment, the device 204 may send the authentication details to the service 210 without prompting the user to provide the authentication details. After receiving the authentication details, the service 210 sends 314 session details to the device 204 that include one or more region size limits. The region size limit indicate one or more limits, such as a maximum limit and/or a minimum limit, on an allowed size of a user-selected authentication region that encompasses a location of the device 204 at the time of registration of the authentication region. In response to receiving the session details, the device 204 captures 316 location information associated with a location of the device 204. In particular embodiments, the device 204 captures 316 the location information using global positioning system (GPS) signals, cellular signals, or any other suitable location determination procedure.

In the example registration process 300, the device 204 requests 318 a region size from the user 202, and the user 202 provides 320 the selected region size to the device 204 within the limits of the region size limits received from the service 210. In particular embodiments, the specific area encompassed by the selected authentication region may be as accurate as the user 202 desires as long as it meets the requirements of the region size limits and is large enough to cover the area from which the user intends to authenticate. The device 204 hashes 322 the region encompassed by the selected region size using a secure key. In particular embodiments, the secure key may include, for example, a device-generated signature or a user password.

The device 204 registers 324 the new hashed authentication region by sending the new hashed authentication region to the service 210. In response to receiving the new hashed authentication region, the service 210 stores the new hashed authentication region in a set of authenticated hashed regions associated with the user 202 and/or device 204 for use in later authentication of the user 202 during establishment of a session with the service 210. The service 210 confirms 326 the registration of the new authentication region with the user 202. In particular embodiments, the service 210 confirms 326 the registration of the new authentication region with the user via an out-of-band communication such as an e-mail or text message. In one or more embodiments, the registration process 300 is performed for each of a plurality of authentication regions by the user 202.

For further explanation, FIG. 4 is a process flow diagram illustrating an example authentication process 400 for obscured location verification in accordance with embodiments of the present disclosure. In the example authentication process 400, the user 202 and device 204 are located in a location covered by a registered authentication region, and the user 202 desires to authenticate with the service 210 to establish a session between the device 204 and the service 210 to receive the service 210. The user 202 logins 402 to the service 210 by providing authentication details to the device 204, and the device 204 sends 404 the authentication details to the service 210. The service 210 establishes 406 an unvalidated session sends a location challenge and region size limits to the device 204. The device 204 captures 408 location information associated with the location of the device 204. In particular embodiments, the device 204 captures 408 the location information using global positioning system (GPS) signals, cellular signals, or any other suitable location determination procedure.

The device 204 enters a loop in which for each of a number of possible region sizes, the device hashes 410 each region size with the secure key. In a particular embodiment, the number of possible region sizes include each of the regions sizes previously authenticated by the user 202 with the service 210. As previously discussed, in particular embodiments the secure key may include, for example, a device-generated signature or a user password. The device 204 then sends 412 each of the hashed authenticated regions to the service 210. The service 210 verifies 414 the authentication region by comparing the hash associated with each of the hashed region sizes with the hashes associated with the previously stored authenticated regions. If the hash of a received region size matches one or more of the hashes of the registered authenticated regions, the service 210 establishes 416 a validated session with the device 204. If none of the hashes of a receive region size matches a hash of the registered authentication regions, the service 210 invalidates 418 the session. The device 204 then notifies 420 the user whether the session has been validated.

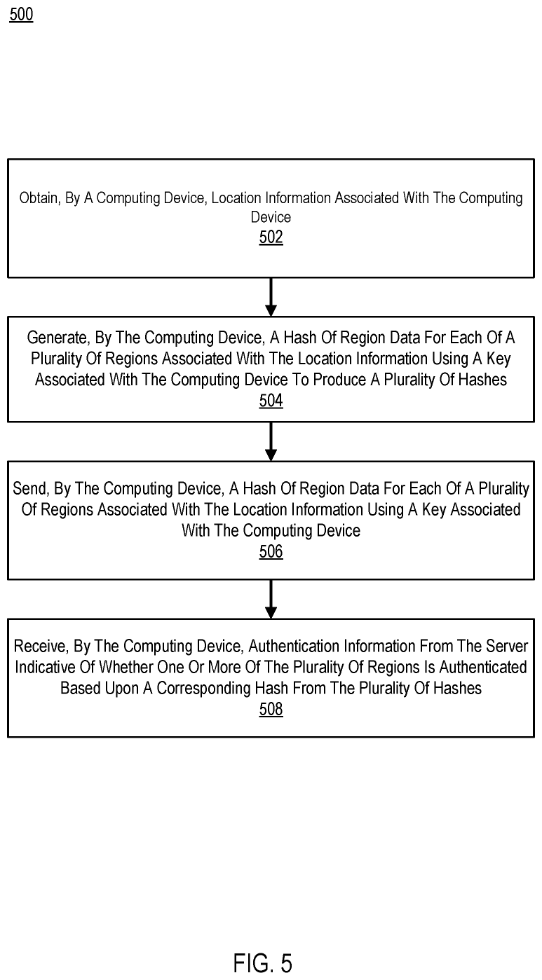

For further explanation, FIG. 5 sets forth a flowchart illustrating an example method 500 of obscured location verification in accordance with embodiments of the present disclosure. In the example method of FIG. 5, a user wishes to authenticate with a server to access a service based on authentication regions previously registered by the user. The method of FIG. 5 includes obtaining 502, by a computing device, location information associated with the computing device. In an embodiment, the location information is indicative of a current location by the computing device. In particular embodiments, the computing device captures the location information using global positioning system (GPS) signals, cellular signals, or any other suitable location determination procedure.

The method further includes generating 504, by the computing device, a hash of region data for each of a plurality of regions associated with the location information using a key associated with the computing device to produce a plurality of hashes. In particular embodiments, the plurality of regions are regions having different region sizes. In a particular embodiment, the key is a passphrase or password received from a user of the computing device. In another particular embodiment, the key is a device-specific key associated with the computing device. In another particular embodiment, the device-specific key is generated by the computing device. In one or more embodiments, the region data for each of the plurality of regions comprises a region size of each of the associated regions. In one or more embodiments, the computing device receives an indication from the server of valid region sizes for the plurality of regions and receives a selection of a region sizes from among the valid regions sizes for each of the plurality of regions from the user of the computing device.

The method of FIG. 5 further includes sending 506, by the computing device, the plurality of hashes to a server. In one or more embodiments, the server is configured to provide a service to the user of the computing device. In one or more embodiments, the server is configured to authenticate the computing device based upon a comparison of the corresponding hash for each of the plurality of regions to one or more hashes associated with a set of authenticated regions. In various embodiments, the server stores the set of authenticated regions in association with the computing device and/or user in response to a previous registering of each of the authenticated regions by the user. The method further includes receiving 508, by the computing device, authentication information from the server indicative of whether one or more of the plurality of regions is authenticated based upon a corresponding hash from the plurality of hashes.

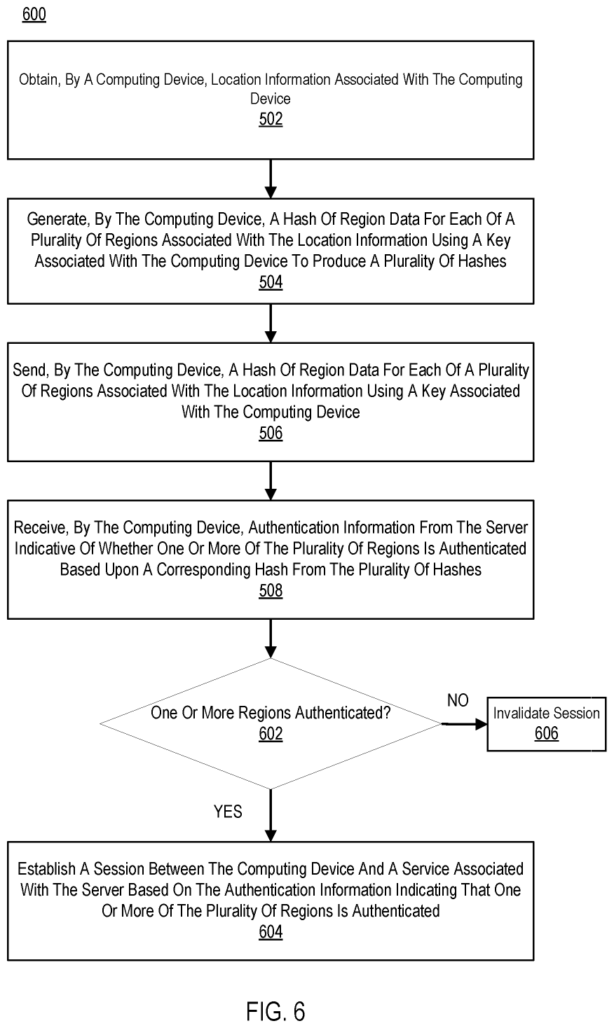

For further explanation, FIG. 6 sets forth a flowchart illustrating another example method 600 of obscured location verification in accordance with embodiments of the present disclosure. The method of FIG. 6 continues with the method of FIG. 5 by further including determining 602 if one or more regions is authenticated based on the received authentication information. If one or more regions are authenticated, a session is established 604 between the computing device and the service associated with the server based on the authentication information indicating that one or more of the plurality of regions is authenticated. If none of the one or more regions are authenticated, the session is invalidated 606.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for obscured location verification, comprising:
obtaining, by a computing device, location information associated with the computing device;
generating, by the computing device, a hash of region data for each of a plurality of regions associated with the location information using a key associated with the computing device to produce a plurality of hashes;
sending, by the computing device, the plurality of hashes to a server; and
receiving, by the computing device, authentication information from the server indicative of whether one or more of the plurality of regions is authenticated based upon a corresponding hash from the plurality of hashes.

2. The method of claim 1, wherein the key comprises a passphrase received from a user of the computing device.

3. The method of claim 1, wherein the key is a device-specific key associated with the computing device.

4. The method of claim 1, wherein the region data for each of the plurality of regions comprises a region size of each of the associated regions.

5. The method of claim 1, further comprising establishing a session between the computing device and a service associated with the server based on the authentication information indicating that one or more of the plurality of regions is authenticated.

6. The method of claim 1, further comprising receiving an indication from the server of valid region sizes for the plurality of regions.

7. The method of claim 6, further comprising receiving a selection of a region sizes from among the valid regions sizes for each of the plurality of regions from a user of the computing device.

8. The method of claim 1, wherein the server is configured to authenticate the computing device based upon a comparison of the corresponding hash for each of the plurality of regions to one or more hashes associated with a set of authenticated regions.

9. An apparatus for obscured location verification, the apparatus comprising a computer processor, a computer memory operatively coupled to the computer processor, the computer memory having disposed within it computer program instructions that, when executed by the computer processor, cause the apparatus to:
obtain, by a computing device, location information associated with the computing device;
generate, by the computing device, a hash of region data for each of a plurality of regions associated with the location information using a key associated with the computing device to produce a plurality of hashes;
send, by the computing device, the plurality of hashes to a server; and
receive, by the computing device, authentication information from the server indicative of whether one or more of the plurality of regions is authenticated based upon a corresponding hash from the plurality of hashes.

10. The apparatus of claim 9, wherein the key comprises a passphrase received from a user of the computing device.

11. The apparatus of claim 9, wherein the key is a device-specific key associated with the computing device.

12. The apparatus of claim 9, wherein the region data for each of the plurality of regions comprises a region size of each of the associated regions.

13. The apparatus of claim 9, wherein the computer program instructions further cause the apparatus to establish a session between the computing device and a service associated with the server based on the authentication information indicating that one or more of the plurality of regions is authenticated.

14. The apparatus of claim 9, wherein the computer program instructions further cause the apparatus to receive an indication from the server of valid region sizes for the plurality of regions.

15. The apparatus of claim 14, wherein the computer program instructions further cause the apparatus to receive a selection of a region sizes from among the valid regions sizes for each of the plurality of regions from a user of the computing device.

16. The apparatus of claim 9, wherein the server is configured to authenticate the computing device based upon a comparison of the corresponding hash for each of the plurality of regions to one or more hashes associated with a set of authenticated regions.

17. A computer program product for obscured location verification, the computer program product disposed upon a computer readable medium, the computer program product comprising computer program instructions that, when executed, cause a computer to:
obtain, by a computing device, location information associated with the computing device;
generate, by the computing device, a hash of region data for each of a plurality of regions associated with the location information using a key associated with the computing device to produce a plurality of hashes;
send, by the computing device, the plurality of hashes to a server; and
receive, by the computing device, authentication information from the server indicative of whether one or more of the plurality of regions is authenticated based upon a corresponding hash from the plurality of hashes.

18. The computer program product of claim 17, wherein the key comprises a passphrase received from a user of the computing device.

19. The computer program product of claim 17, wherein the key is a device-specific key associated with the computing device.

20. The computer program product of claim 17, wherein the computer program instructions further cause the computer to establish a session between the computing device and a service associated with the server based on the authentication information indicating that one or more of the plurality of regions is authenticated.
